(19) United States
(12) Patent Application Publication
(10) Pub. No.: US 2007/0022219 A1
(43) Pub. Date: Jan. 25, 2007

(54) Information processing apparatus and method for initializing flow control

(75) Inventor: Yoshiki Yasui, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/529,288

(22) Filed: Sep. 29, 2006

Related U.S. Application Data
(63) Continuation of application No. PCT/JP05/03862, filed on Mar. 7, 2005.

(30) Foreign Application Priority Data
Mar. 31, 2004 (JP) 2004-108047

(51) Int. Cl. G06F 15/16

(52) U.S. Cl. 709/253; 709/213

(57) ABSTRACT

In a flow control initialization method and an information processing apparatus, a first component enters a first initialization mode and sends a first first-component initial value to a second component. Subsequently, upon receipt of a first second-component initial value or a second second-component initial value from the second component, the first component enters a second initialization mode and sends a second first-component initial value to the second component. Upon receipt of the second second-component initial value, a second-component flow control value, or a transaction layer packet from the second component, the first component completes the initialization process, and then sends at least one of a first-component flow control value and a transaction layer packet to the second component at least one time.

### CROSS-REFERENCE TO RELATED APPLICATION

This application is a continuation of PCT application No. PCT/JP2005/003862 filed Mar. 7, 2005, which relies for priority on Japanese Patent Application No. 2004-108047, filed Mar. 31, 2004, the entire contents of which are incorporated herein by reference.

### BACKGROUND

1. Field

The present invention relates to an information processing apparatus and a method for initializing flow control and, in particular, to an information processing apparatus having means for initializing flow control of a high-speed serial bus and to a method for initializing flow control of a high-speed serial bus.

2. Description of the Related Art

In recent years, the processing speed of central processing units (CPUs) in information processing apparatuses has increased remarkably.

With the increase in processing speed of CPUs, the data transfer rate of data buses, which connect various types of devices with a CPU, has also increased.

Data buses of information processing apparatuses can be grouped into three categories: ultrahigh-speed data buses, high-speed data buses, and low-speed data buses.

The highest speed is required for a data bus that interconnects a CPU and a main memory unit. This bus is referred to as an “ultrahigh-speed data bus”, and is also referred to as “memory bus” or “processor bus”.

A high speed is required for a data bus that interconnects a CPU and a graphics control unit, which controls the display of an information processing apparatus, and a high-speed peripheral unit, such as a hard disk. This bus is referred to as a “high-speed data bus”.

A data bus that interconnects a CPU with a low-speed peripheral unit, such as a keyboard, a mouse, and a floppy disk drive, is referred to as a “low-speed data bus”.

Data transfer methods include a parallel transfer method that transfers bit signals of data in parallel (a data bus for this method is referred to as a parallel bus) and a serial transfer method that transfers bit signals in series (a data bus for this method is referred to as a serial data bus). In general, the ultrahigh-speed data bus and the high-speed data bus adopt the parallel transfer method, while the low-speed data bus adopts the serial transfer method.

The speed of each of these data buses has increased. In particular, a further speed-up of the high-speed data bus is required, since the amount of transfer data for devices connected to the high-speed data bus, for example, a graphics control unit or a LAN card, has significantly increased.

Known high-speed data buses are parallel buses that adopt a parallel transfer method, for example, PCI buses. To increase the data transfer rate of a parallel bus, the bit width, that is, the number of signals simultaneously transmitted, must be expanded and the transfer clock frequency increased.

For example, the transfer rate of the PCI bus has been increased by expanding the bit width from 16 bits to 32 bits, and now to 64 bits.

Additionally, the transfer clock frequency has been increased, for example, from 33 MHz to 66 MHz, and now to 133 MHz.

However, the increase in the transfer rate of the parallel bus causes the following problems: (1) In the parallel transfer method, bits of data must be simultaneously transferred over parallel signal lines and must be simultaneously received in synchronization with a transfer clock. However, as the speed of the transfer clock increases, a delay time of each bit signal of the parallel data becomes more critical. As a result, the bits of data transferred in parallel cannot always be received at the same time; (2) In the parallel transfer method, all the bit signals are transferred over physically close lines. Accordingly, each bit signal is affected by noise from other bit signals. At a relatively low transfer clock frequency, this noise problem does not occur. However, at a high transfer clock frequency, the noise problem is critical.

An increase in the transfer rate in the parallel transfer method is limited due to these problems.

To achieve a further increase in the transfer rate, data transfer by a serial transfer method is proposed, as is disclosed in “PCI Express™ Base Specification Revision 1.0a”, [online], Apr. 15, 2003, PCI-SIG, Retrieved from the Internet <URL: http://www.pcisig.com/specifications/pciexpress/>on Feb. 2004 (hereinafter referred to as Non-Patent Document 1). According to this serial transfer method, the above-described problems (1) and (2) do not occur. Therefore, the transfer clock can be increased to an extremely high frequency, for example, 2.5 Gbits per second (Gbps), thus increasing the data transfer rate.

In addition, a plurality of serial transfer lines between a data transfer initiating device and a target device can provide a further increase in the data transfer rate in the serial transfer method.

As described above, the high-speed serial bus is being increasingly used as the data bus of information processing apparatus. For example, a bus complying with the PCI Express™ specification is used. “PCI Express” is a trademark of the PCI Special Interest Group (PCI-SIG).

While such a high-speed serial bus can be connected to a plurality of peripheral devices via a device called a switch, these connections are basically point-to-point connections.

In point-to-point data transfer, to prevent an overflow of transferred data in a target device, the transfer rate of the data is controlled. If an overflow is likely to occur, the data transfer is often stopped. This is known as flow control.

However, a known flow control technique of PCI Express™ has the disadvantage that an initialization process of the flow control may not be completed, depending on the types and settings of components.

### SUMMARY OF THE INVENTION

Accordingly, it is an object of the present invention to provide an improved flow control method for a high-speed serial bus and to provide an information processing apparatus having means for executing the flow control.

According to the present invention, in a method for initializing flow control between a first component and a second component, the first component is connected to the second component via a serial bus, the first component sends a first first-component initial value in a first initialization mode of the first component and sends a second first-component initial value in a second initialization mode of the first component, and the second component sends a first second-component initial value in a first initialization mode of the second component and sends a second second-component initial value in a second initialization mode of the second component. The method includes a first step of causing the first component to enter the first initialization mode; a second step of causing the first component to send the first first-component initial value to the second component; a third step of causing the first component to enter the second initialization mode when the first component receives the first second-component initial value or the second second-component initial value from the second component; a fourth step of causing the first component to send the second first-component initial value to the second component; a fifth step of causing the first component to enter an initialization complete mode when the first component receives the second second-component initial value, a second-component flow control value, or second-component data from the second component; and a sixth step of causing the first component to send at least one of a first-component flow control value and first-component data to the second component at least one time.

According to the present invention, an information processing apparatus includes a first component; a second component connected to the first component via a serial bus; initialization means for initializing flow control between the first component and the second component, in which the first component sends a first first-component initial value in a first initialization mode of the first component and sends a second first-component initial value in a second initialization mode of the first component, and the second component sends a first second-component initial value in a first initialization mode of the second component and sends a second second-component initial value in a second initialization mode of the second component; means for causing the first component to enter the first initialization mode; means for causing the first component to send the first first-component initial value to the second component; means for causing the first component to enter the second initialization mode when the first component receives the first second-component initial value or the second second-component initial value from the second component; means for causing the first component to send the second first-component initial value to the second component; means for causing the first component to enter an initialization complete mode when the first component receives the second second-component initial value, a second-component flow control value, or second-component data from the second component; and means for causing the first component to send at least one of a first-component flow control value and first-component data to the second component at least one time.

According to the present invention, the initialization method for the flow control and the information processing apparatus allow the initialization process to be completed regardless of the types and settings of the components.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an external view of an information processing apparatus according to a first embodiment of the present invention;

FIG. 2 shows an example of the hardware architecture of the information processing apparatus according to the present invention;

FIGS. 3A and 3B show basic components of a serial bus for explaining an initialization process of flow control according to the present invention;

FIG. 4 is a first diagram for explaining packet creation steps in the initialization process of flow control according to the present invention;

FIG. 5 is a second diagram for explaining packet creation steps in the initialization process of flow control according to the present invention;

FIGS. 6A and 6B are diagrams for explaining a data link layer packet (DLLP) in the initialization process of flow control according to the present invention;

FIG. 7 is a flow chart of a known initialization process of flow control;

FIG. 8 is a diagram for showing drawbacks in the known initialization process of flow control;

FIG. 9 shows an initialization process of flow control according to a first embodiment of the present invention;

FIG. 10 shows an initialization process of flow control according to a second embodiment of the present invention; and

FIG. 11 shows an initialization process of flow control according to a third embodiment of the present invention.

### DETAILED DESCRIPTION

The embodiments of an initialization method for flow control and the information processing apparatus according to the present invention will be described below with reference to the accompanying drawings.

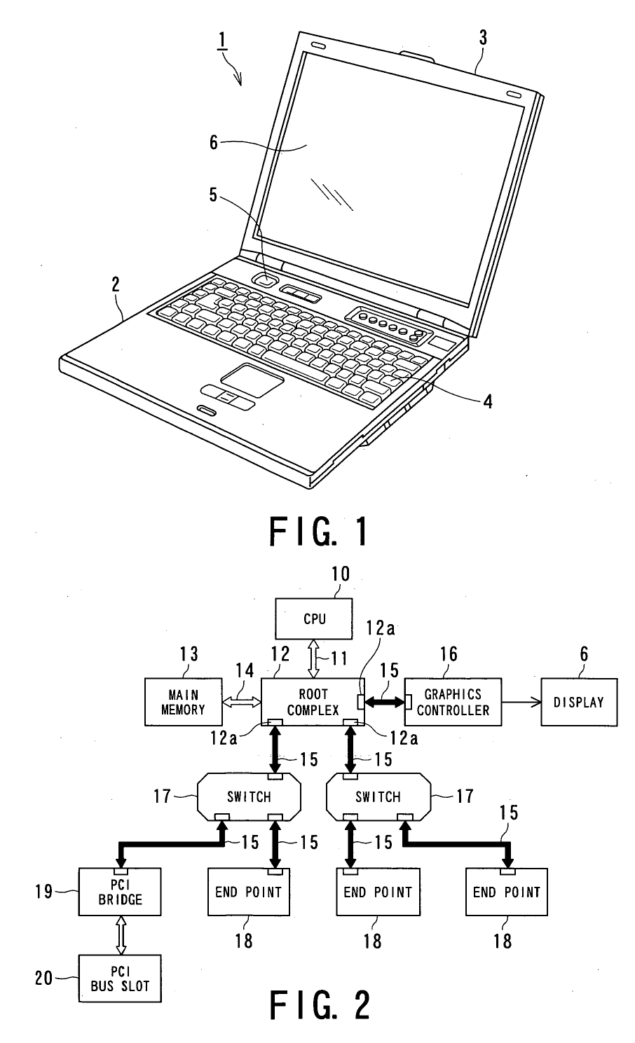

FIG. 1 is an external view of an information processing apparatus having means for executing flow control according to a first embodiment of the present invention.

An information processing apparatus 1 includes, for example, a thin box-like body 2 and a panel unit 3 attached to the body 2 so as to be openable and closable.

On an upper surface of the body 2, a keyboard 4 and a power switch 5 are disposed. The keyboard 4 is used to operate the information processing apparatus 1 and to input various types of data to the information processing apparatus 1.

The panel unit 3 includes a display 6 for displaying various types of character and graphics information. The display 6 includes, for example, a liquid crystal display (LCD).

According to the present invention, the external view of the information processing apparatus 1 is not limited to the one shown in FIG. 1. The information processing apparatus 1 may have any shape and size. Also, some part, such as the panel unit 3 or the keyboard 4, may be excluded.

FIG. 2 shows an example of the hardware architecture of the information processing apparatus 1.

A key part of the information processing apparatus 1 is a central processing unit (CPU) 10, which carries out various types of control of the information processing apparatus 1 and carries out processing and computation of data. The CPU 10 is connected to a root complex 12 via a CPU bus 11. The CPU bus 11 is normally a parallel bus.

A main memory 13 temporarily stores various types of programs and data. The main memory 13 is connected to the root complex 12 via a memory bus 14. The memory bus 14 is normally a parallel bus as well.

The root complex 12 converts a bus signal of the CPU bus 11 to a bus signal of the memory bus 14, and vice versa. This function is the same as that of a bus signal converting chipset, which is a circuit composed of an LSI mainly used to convert bus signals, known as a North Bridge or a memory bridge.

Another key feature of the root complex 12 is that, by converting a bus signal of the CPU bus 11 to a signal of a high-speed serial bus 15, it allows the CPU bus 11 to communicate with each device of the information processing apparatus 1 via a single or a plurality of root ports 12a.

Herein, the high-speed serial bus 15 complies with, for example, the PCI Express™ specification disclosed in Non-Patent Document 1.

The root complex 12 is connected to a graphics controller 16 via a high-speed serial bus 15, and then is connected to the display 6.

Also, the root complex 12 is connected to a switch 17 via a high-speed serial bus 15. Although two switches 17 are shown in FIG. 2, the root complex 12 may be connected to one or more than two switches.

The switch 17 is further connected to a plurality of endpoints 18 or a PCI bridge 19.

FIG. 2 shows, but is not limited to, an example of the connection of the high-speed serial bus 15. The point is that a hierarchical connection structure with the root complex 12 at the top can be achieved. For example, the hierarchical connection structure can be expanded by connecting another switch 17 to the switch 17.

As used herein, the endpoint 18 is a generic term for an endpoint component connected via the high-speed serial bus 15 in the hierarchical connection structure.

Accordingly, the endpoint 18 may be any type of component. For example, the endpoint 18 may be an auxiliary storage device, such as a hard disk drive (HDD). Alternatively, the endpoint 18 may be a drive including a CD-ROM drive and a DVD drive, or a local area network (LAN) interface. That is, the endpoint 18 generally refers to a component at the endpoint of the hierarchical connection structure.

The high-speed serial bus 15 can be connected, via the PCI bridge 19, to a known PCI bus slot 20, to which various types of PCI devices can be connected.

Although FIG. 2 shows a hierarchical connection structure in which all the components except for the CPU bus 11 and the memory bus 14 are connected with each other via the high-speed serial bus 15, various other types of buses, such as a USB bus and a PCI bus, may be mixed in the hierarchical connection structure.

As shown in FIG. 2, the high-speed serial bus 15 connects a particular component with a particular component in a point-to-point manner. For example, two particular components are the root complex 12 and the graphics controller 16. Alternatively, the two particular components may be the switch 17 and the endpoint 18.

The present invention relates to bus communication of the high-speed serial bus 15 and, in particular, to an initialization method of flow control of the communication, not to all the features of the high-speed serial bus 15. Therefore, a component connected to the high-speed serial bus 15 may be of any type.

Consequently, hereinafter, one of two components connected to the high-speed serial bus 15 is referred to as a first component, and the other component is referred to as a second component. In terms of an initialization method of flow control of communication of the high-speed serial bus 15, the two components perform the same function. For the sake of brevity, only the first component will be described below.

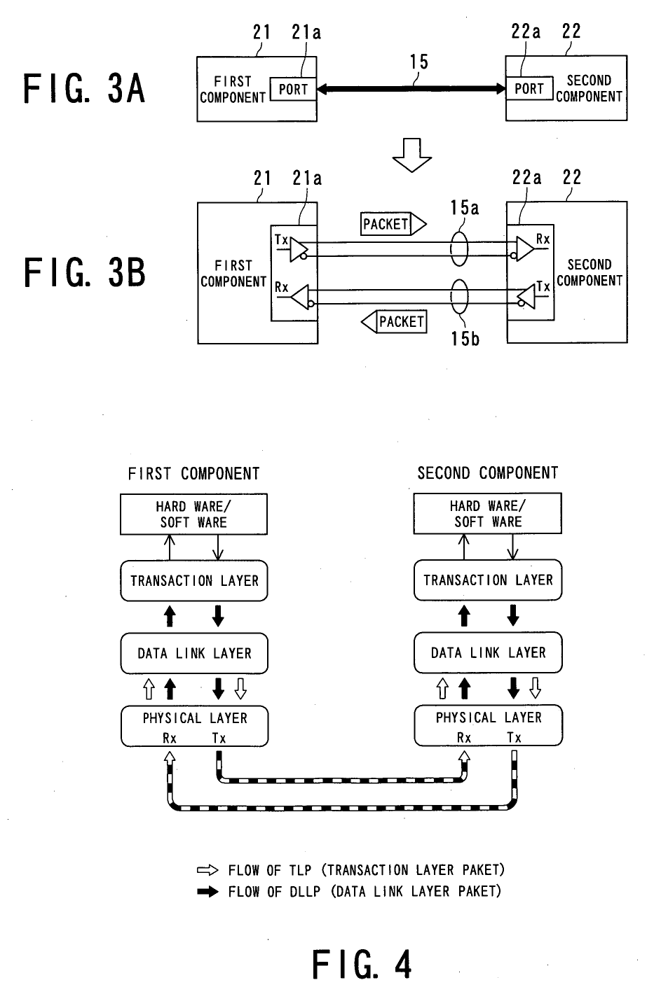

FIGS. 3A and 3B show components of the basic configuration of the high-speed serial bus 15. The basic configuration includes a first component 21, a second component 22, and the high-speed serial bus 15 that connects the first component 21 with the second component 22.

The high-speed serial bus 15 is a bidirectional serial bus. The speeds of the bidirectional communication are the same, for example, 2.5 Gbps.

As shown in FIG. 3B, a basic hardware configuration includes two transmission lines 15a, over which the first component 21 transmits a signal to the second component 22 in a differential transfer scheme, and two transmission lines 15b, over which the first component 21 receives a signal from the second component 22 in a differential transfer scheme. The four transmission lines form one unit of the bidirectional serial bus. The unit is referred to as a lane.

Two components can be connected by a plurality of lanes. The plurality of lanes is referred to as a link.

The high-speed serial bus 15 transmits a series of bits of a predetermined length as a set. The set is referred to as a packet.

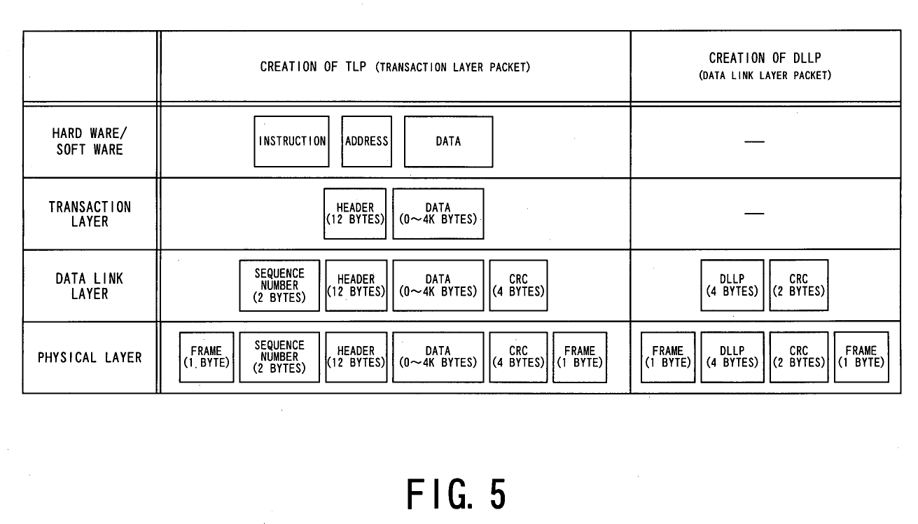

The concept of the packet is essential for the transfer method of the high-speed serial bus 15. Accordingly, the concept will be schematically described next with reference to FIGS. 4 and 5.

FIG. 4 shows information flow between the first component 21 and the second component 22. This information includes, for example, a predetermined instruction, a predetermined memory address, and various types of data.

For example, the first component 21 is the root complex 12 shown in FIG. 2, the second component 22 is a storage device, and the CPU 10 writes data into the storage device. In this case, the root complex 12 receives an instruction (a write instruction), a memory address of the storage device, and data to be written from the CPU 10, and then transmits this information to the storage device, namely, the second component 22.

When the data is transmitted, the data is divided into packets. The packets are created in the following three communication layers: a transaction layer, a data link layer, and a physical layer.

The packets are grouped into two types. One type of packet is a packet called a transaction layer packet (TLP), which is primarily created in the transaction layer. For example, an instruction, a memory address, and data to be written are divided into data of a predetermined length to create the TLP.

Data transmitted from the first component is divided into packets referred to as TLP1 (first-component data). Data transmitted from the second component is divided into packets referred to as TLP2 (second-component data).

The other type of packet is a packet called a data link layer packet (DLLP), which is independently created in the data link layer.

The DLLP is a packet used for flow control, that is, a packet used to control a flow of data transmission between the two components.

The TLP and DLLP are transmitted between the physical layers of the two components in a time-multiplexing manner.

FIG. 5 shows a process of how a TLP and a DLLP are created in the three layers. To create a TLP, data to be transmitted is divided into data of a predetermined length (maximum 4 Kbytes) in the transaction layer, and a first packet including a header having an instruction and an address is created.

Subsequently, a sequence number, which indicates a number for the divided packet, and cyclic redundancy check (CRC) bits, which are used to detect a transmission error, are added to the packet in the data link layer.

Finally, in the physical layer, a frame is added before and after the packet to obtain a TLP.

In contrast, the DLLP is a packet for flow control independently created in the data link layer. The DLLP includes 4-byte DLLP data and a 2-byte CRC. In the physical layer, a 1-byte frame is added before and after the packet. The length of the DLLP is 8 bytes in total, and remains unchanged regardless of a content of the DLLP data.

When the second component 22 detects an error in a TLP1 transmitted from the first component 21, the second component 22 returns a notification of the error detection (Nak) and the sequence number of the erroneous TLP1 to the first component 21. When no error is detected, the second component 22 returns a positive acknowledgement (Ack) and the sequence number of the received TLP1. In the case of receiving a Nak, the first component 21 re-transmits the TLP1 having the same sequence number to the second component 22.

In the transfer method of the high-speed serial bus 15, a credit-based flow control is further carried out by using the DLLP.

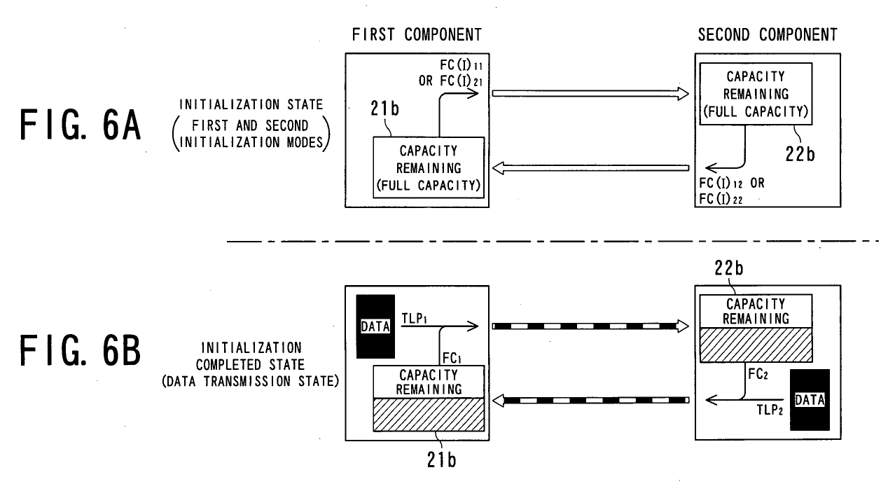

FIG. 6 is a diagram for explaining the concept of the credit-based flow control.

The word “credit-based” means that an initiating component carries out flow control based on a “credit” of the target component.

More specifically, the “credit” of the target component is determined based on the capacity remaining in the receive buffer of the target component. High credit refers to a state in which the target component has a sufficient capacity remaining in the receive buffer, while low credit refers to a state in which the target component has a small capacity remaining in the receive buffer.

When the capacity remaining in the receive buffer of the target component becomes small, the initiating component temporarily stops transmitting the data so as to prevent an overflow of the data in the receive buffer of the target component.

To achieve such flow control, the initiating component must receive the capacity remaining in the receive buffer of the target component on a timely basis during data transmission.

The DLLP is used for this function. By using the DLLP, the capacity remaining in the receive buffer of a component is returned to a component at the other end.

FIG. 6B shows a data transmission state after initialization is completed. The first component 21 embeds the capacity remaining in its receive buffer 21b into DLLP data and sends the DLLP data. This DLLP data is referred to as a first-component flow control value (abbreviated as FC1). The FC1 and a TLP1 are transmitted to the second component 22 in a time-multiplexing manner. Similarly, the second component 22 embeds the capacity remaining in its receive buffer 22b into DLLP data and sends it. This DLLP data is referred to as a second-component flow control value (abbreviated as FC2). The FC2 and a TLP2 are transmitted to the first component 21 in a time-multiplexing manner.

FIG. 6A shows an initialization state before the two components start data transmission. Since this is a state before data transmission, capacities remaining in receive buffers of both components exhibit full capacities.

The initialization of the flow control means that an initiating component transmits a full capacity in its receive buffer to the target component and receives a full capacity in the receive buffer of the target component. After the first component 21 transmits a full capacity in its receive buffer 21b to the second component 22 and receives a full capacity in the receive buffer 22b of the second component 22 from the second component 22, the initialization of the second component 22 is completed.

Both initializations do not necessarily start at the same time. To ensure correct initializations even in such a case, each of the initializations has two steps: a first initialization mode and a second initialization mode.

In a first initialization mode of the first component 21, the full capacity of the receive buffer 21b to be transmitted to the second component 22 is referred to as a first first-component initial value (abbreviated as “FC(I)11”).

In a second initialization mode of the first component 21, the full capacity of the receive buffer 21b to be transmitted to the second component 22 is referred to as a second first-component initial value (abbreviated as “FC(I)21”). Although the types of packets FC(I)11 and FC(I)21 are different, the contents of the data are the same, that is, the full capacity of the receive buffer 21b.

Similarly, in a first initialization mode of the second component 22, the full capacity of the receive buffer 22b to be transmitted to the first component 21 is referred to as a first second-component initial value (abbreviated as “FC(I) 12”).

Also, in a second initialization mode of the second component 22, the full capacity of the receive buffer 22b to be transmitted to the first component 21 is referred to as a second second-component initial value (abbreviated as “FC(I)22”).

Additionally, the FC(I)12 and FC(I)22 contain the same data, that is, the full capacity of the receive buffer 22b.

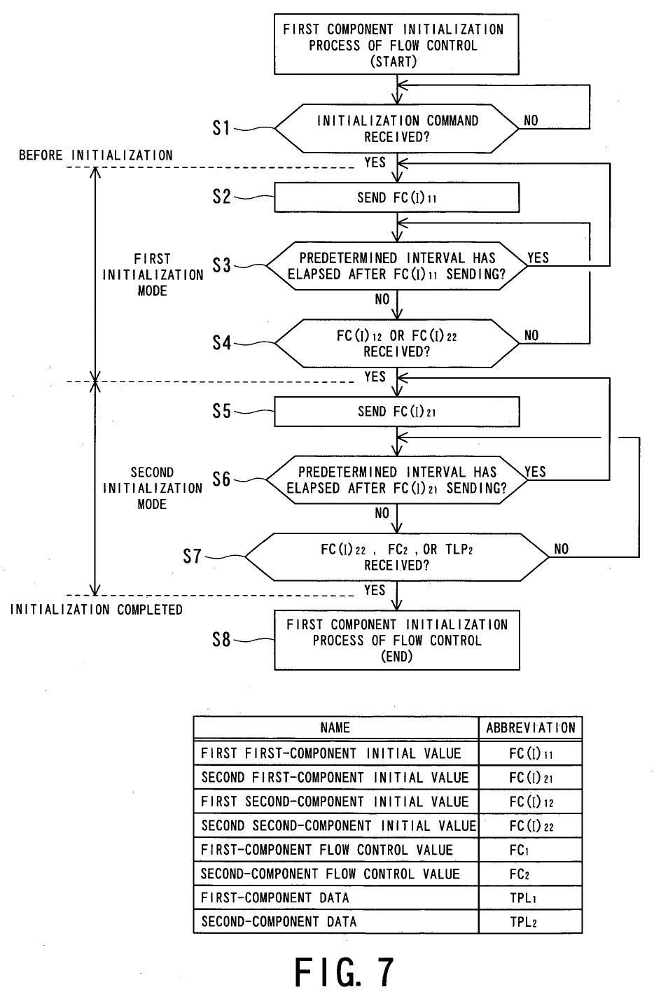

FIG. 7 is a flow chart of a known initialization process of flow control disclosed in Non-Patent Document 1. Although FIG. 7 is a flow chart for the first component 21, this drawing also shows a flow chart for the second component 22.

First, the first component 21 waits for an initialization command delivered from, for example, upper-level software (step S1). For example, when the information processing apparatus 1 is powered on, initialization commands are delivered to the first component 21 and the second component 22 as well as, in this case, other component pairs.

Additionally, for example, when the second component is connected to the information processing apparatus 1 that is powered on, that is, when the second component is hot-plugged to the information processing apparatus 1, initialization commands are delivered to both components.

Upon receipt of the initialization command, the first component 21 enters a first initialization mode, and then sends the FC(I)11 to the second component 22 (step S2).

The first component 21 sends the FC(I)11 at predetermined intervals. Accordingly, it is determined whether or not the predetermined interval elapses. If the predetermined interval has elapsed (in the case of “yes” at step S3), the FC(I)11 is re-sent.

If the first component 21 receives the FC(I)12 or the FC(I)22 from the second component 22 (in the case of “yes” at step S4) before the predetermined interval elapses (in the case of “no” at step S3), the first component 21 enters a second initialization mode.

On the other hand, if the first component 21 does not receive the FC(I)12 or the FC(I)22 (in the case of “no” at step S4), the first component 21 stays in the first initialization mode until the first component 21 receives the FC(I)12 or the FC(I)22, while continuing to send the FC(I)11 at the predetermined intervals.

In the second initialization mode, the first component 21 sends FC(I)21 to the second component 22 (step S5). The FC(I)21 is also sent at predetermined time intervals (step S6).

In the second initialization mode, upon receipt of either FC(I)22, FC2, or TLP2 (in the case of “yes” at step S7), the initialization process of the first component 21 is completed (step S8).

On the other hand, if the first component 21 receives neither FC(I)22, FC2, or TLP2 (in the case of “no” at step S7), the first component 21 stays in the second initialization mode until the first component 21 receives either FC(I)22, FC2, or TLP2, while continuing to send the FC(I)21 at the predetermined intervals.

In other words, the initialization process of the first component 21 is not completed until either FC(I)22, FC2, or TLP2 is received.

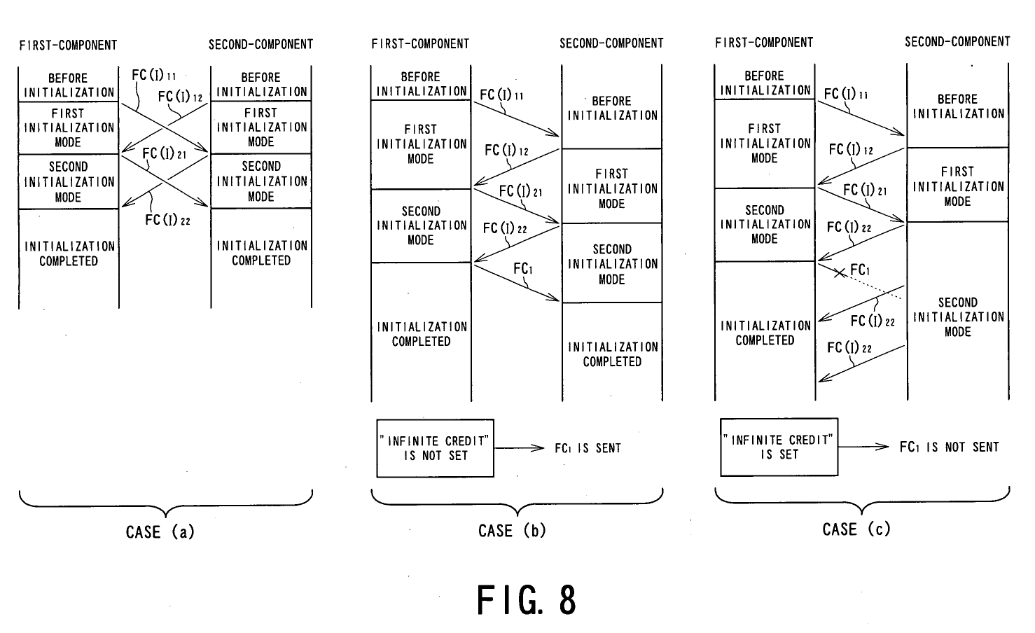

FIG. 8 shows three cases of the initialization processes of the first component 21 and the second component 22 that follow the flow chart shown in FIG. 7.

In the case (a) shown in FIG. 8, initialization commands are delivered to the first component 21 and the second component 22 substantially at the same time. In this case, since both components sequentially receive FC(I)11, FC(I)21, FC(I)12, and FC(I)22, both components can complete their initialization processes.

In the case (b) shown in FIG. 8, an initialization command for the second component 22 lags behind an initialization command for the first component 21. In this case, an initialization process of the first component 21 is completed earlier than that of the second component 22. After the initialization process of the first component 21 is completed, the first component 21 sends either an FC1 or a TLP1.

On the other hand, upon receipt of the FC(I)21, FC1 or TLP1, the initialization of the second component 22 is completed, as shown in FIG. 7 (in this case, although the process shown in FIG. 7 is described for the first component 21, it should be read as a process for the second component 22, that is, step S7 should be read as “FC(I)21 or FC1 or TLP1 received?”).

Since the initialization process of the first component 21 is completed, the FC(I)21 is not sent, and therefore, either FC1 or TLP1, or both FC1 and TLP1 are sent.

In the case (b), the initialization process of the second component 22 can be completed by receiving the FC1.

As described above, the high-speed serial bus 15 employs a credit-based flow control. The specification disclosed in Non-Patent Document 1 allows for the credit to be set to “infinite”. The word “infinite” for the credit setting refers to having an infinite-capacity receive buffer and having no possibility of an overflow when receiving data.

Additionally, according to the specification disclosed in Non-Patent Document 1, when an infinite flow control credit is set, the capacity of the receive buffer need not be acknowledged to a component at the other end. That is, if the first component 21 is set to “infinite credit”, the first component 21 need not send an FC1 to the second component 22. Eliminating the need for the FC1 transmissions from a component having a sufficient capacity in its receive buffer is aimed at putting a priority on other data (e.g. TLP1) transmissions.

However, in the infinite flow control credit, a problem occurs, as shown by the case (c) in FIG. 8.

The difference between the case (b) and the case (c) is that an “infinite credit” is not set in the case (b) while an “infinite credit” is set in the case (c). In the case of the infinite credit setting, there is a possibility that a FC1 is not sent from the first component 21.

A creation of TLP1 depends on the type of component. When the first component 21 is the root complex 12 and the second component 22 is a storage device, a TLP1 is not created for a long time until the CPU 10 accesses the storage device.

In contrast, if the first component 21 is a slave unit, such as a storage unit, a TLP1 is not created until the second component 22 accesses the first component 21 by using a TLP2.

Therefore, in the case of the infinite credit setting, there is a possibility that the first component 21 creates neither an FC1 nor a TLP1.

As a result, as shown by the case (c) in FIG. 8, there is a possibility that the initialization process of the second component 22 is not completed ever or for a long time. If this happens, the first component 21 cannot communicate with the second component 22.

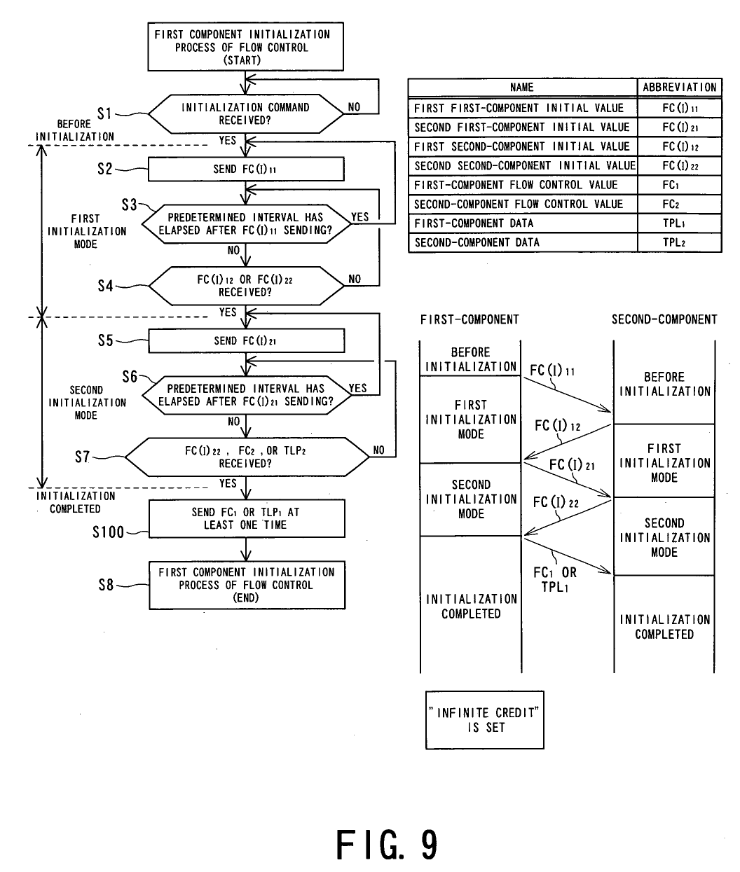

FIG. 9 shows an initialization process of flow control that solves the above-described problem according to a first embodiment of the present invention. The same reference numerals are used to designate the identical processes of Fig. 7.

According to the first embodiment, step S100 is implemented between steps S7 and S8. That is, upon completion of the initialization process of the first component 21 (in the case of “yes” at step S7), the first component 21 sends an FC1 or a TLP1 to the second component 22 at least one time, regardless of an infinite credit setting.

Alternatively, upon completion of the initialization process of the first component 21 (in the case of “yes” at step S7), the first component 21 may send only a FC1 to the second component 22 at least one time regardless of an infinite credit setting.

As a result, the initialization process of the second component 22 can be completed even in the case (c) shown in FIG. 8.

The TLP1 should have no adverse effect on the second component 22. For example, if the second component 22 is a storage device, the TLP1 must not write particular data at a particular address.

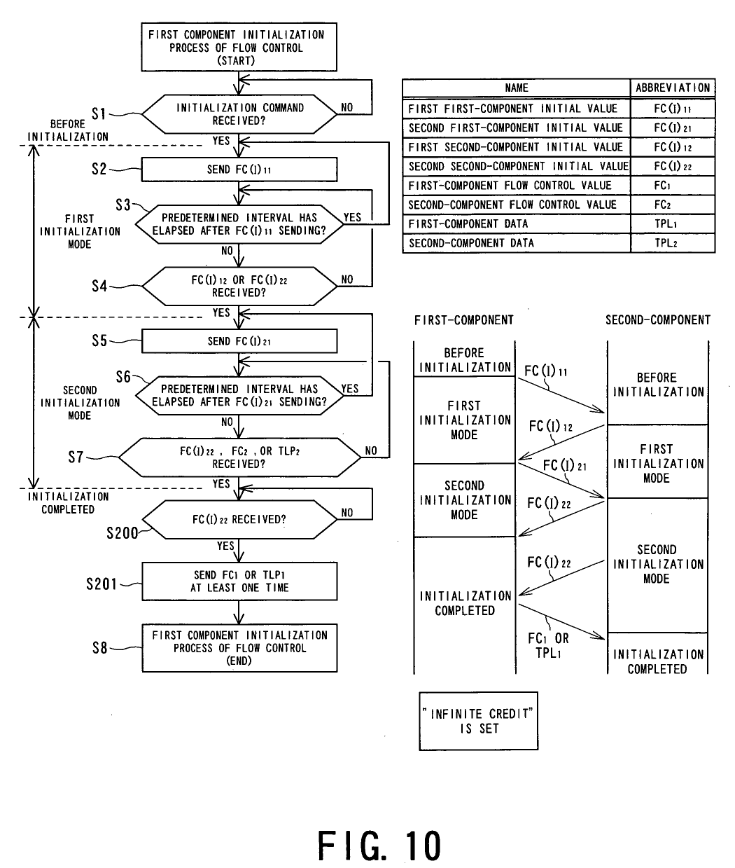

FIG. 10 shows an initialization process of flow control according to a second embodiment of the present invention. The same reference numerals are used to designate the identical processes of FIG. 7.

According to the second embodiment of the present invention, when the first component 21 receives an FC(I)22 from the second component 22 after the first component 21 completes the initialization process (in the case of “yes” at step S200), the first component 21 sends an FC1 or a TLP1 to the second component 22 at least one time, regardless of an infinite credit setting.

Alternatively, when the first component 21 receives a FC(I)22 from the second component 22 after the first component 21 completes the initialization process (in the case of “yes” at step S200), the first component 21 may send only an FC1 to the second component 22 at least one time, regardless of an infinite credit setting.

Receiving an FC(I)22 indicates that the second component 22 is still in the second initialization mode. Accordingly, the second initialization mode of the second component 22 is completed by sending an FC1 or a TLP1 to the second component 22 at least one time.

As in the first embodiment, the TLP1 preferably has no adverse effect on the second component 22.

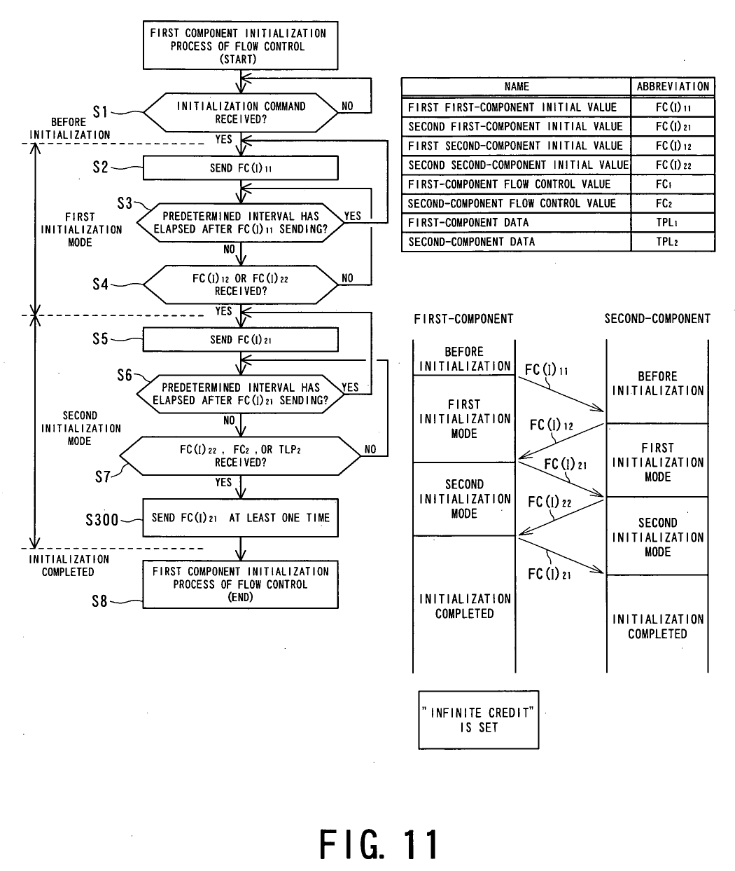

FIG. 11 shows an initialization process of flow control according to a third embodiment of the present invention. The same reference numerals are used to designate the identical processes of FIG. 7.

According to the third embodiment, when the first component 21 is in a second initialization mode, the initialization process is not immediately completed even though the first component 21 receives either FC(I)22, FC2, or TLP2 (in the case of “yes” at step S7). The first component 21 sends an FC(I)21 to the second component 22 at least one time (step 300), and then the initialization process is completed.

As a result, the initialization process of the second component 22 can be completed even in the case (c) in FIG. 8.

Additionally, the initialization processes of flow control shown in FIGS. 9 to 11 may be executed by software or hardware.

It should be understood that the present invention is by no means restricted to the above-described embodiments; rather, in carrying out the invention, various alterations and modifications may be made with regard to the components without departing from the spirit and scope of the present invention. Further, various arrangements may be made within the scope of the present invention by arranging the components in various ways, or by omitting one or more of the components. Moreover, arrangements obtained by suitably combining the components of the above-described embodiments with components of other embodiments according to the present invention are also encompassed by the present invention.

What is claimed is:

1. A method for initializing flow control between a first component and a second component, the first component being connected to the second component via a serial bus, the first component sending a first first-component initial value in a first initialization mode of the first component and sending a second first-component initial value in a second initialization mode of the first component, the second component sending a first second-component initial value in a first initialization mode of the second component and sending a second second-component initial value in a second initialization mode of the second component, the method comprising:
a first step of causing the first component to enter the first initialization mode;
a second step of causing the first component to send the first first-component initial value to the second component;
a third step of causing the first component to enter the second initialization mode when the first component receives the first second-component initial value or the second second-component initial value from the second component;
a fourth step of causing the first component to send the second first-component initial value to the second component;
a fifth step of causing the first component to enter an initialization complete mode when the first component receives the second second-component initial value, a second-component flow control value, or second-component data from the second component; and
a sixth step of causing the first component to send at least one of a first-component flow control value and first-component data to the second component at least one time.

2. The method for initializing flow control according to claim 1, wherein the sixth step is a step of causing the first component to send the first-component flow control value to the second component at least one time.

3. The method for initializing flow control according to claim 1, wherein the sixth step is a step of causing the first component to send at least one of a first-component flow control value and first-component data to the second component at least one time when the first component receives the second second-component initial value from the second component.

4. The method for initializing flow control according to claim 1, wherein the sixth step is a step of causing the first component to send a first-component flow control value to the second component at least one time when the first component receives the second second-component initial value from the second component.

5. The method for initializing flow control according to claim 1, wherein the fifth step is a step of causing the first component to send the second first-component initial value to the second component at least one time when the first component receives the second second-component initial value from the second component, and the sixth step is a step of causing the first component to enter an initialization complete mode.

6. The method for initializing flow control according to claims 1, wherein the serial bus complies with the PCI Express specification.

7. The method for initializing flow control according to claims 2, wherein the serial bus complies with the PCI Express specification.

8. The method for initializing flow control according to claims 3, wherein the serial bus complies with the PCI Express specification.

9. The method for initializing flow control according to claims 4, wherein the serial bus complies with the PCI Express specification.

10. The method for initializing flow control according to claims 5, wherein the serial bus complies with the PCI Express specification.

11. An information processing apparatus comprising:
a first component;
a second component connected to the first component via a serial bus;
initialization means for initializing flow control between the first component and the second component, the first component sending a first first-component initial value in a first initialization mode of the first component and sending a second first-component initial value in a second initialization mode of the first component, the second component sending a first second-component initial value in a first initialization mode of the second component and sending a second second-component initial value in a second initialization mode of the second component;
means for causing the first component to enter the first initialization mode;
means for causing the first component to send the first first-component initial value to the second component;
means for causing the first component to enter the second initialization mode when the first component receives the first second-component initial value or the second second-component initial value from the second component;
means for causing the first component to send the second first-component initial value to the second component;
means for causing the first component to enter an initialization complete mode when the first component receives the second second-component initial value, a second-component flow control value, or second-component data from the second component; and
means for causing the first component to send at least one of a first-component flow control value and first-component data to the second component at least one time.

12. The information processing apparatus according to claim 11, wherein the serial bus complies with the PCI Express specification.
